(19) United States
(12) Patent Application Publication
(10) Pub. No.: US 2025/0034725 A1
(43) Pub. Date: Jan. 30, 2025

(54) HIGH-PRESSURE ELECTROLYSIS DEVICE

(71) Applicant: HYDRO-GEN BV, Werkendam (NL)

(72) Inventor: Arie Meerkerk, Giesenburg (NL)

(73) Assignee: HYDRO-GEN BV, Werkendam (NL)

(21) Appl. No.: 18/709,312

(22) PCT Filed: Nov. 11, 2022
(86) PCT No.: PCT/NL2022/050648

§ 371 Date: May 10, 2024

(30) Foreign Application Priority Data
Nov. 11, 2021 (NL) 2029726

(51) Int. Cl. C25B 9/05; C25B 1/04; C25B 9/015; C25B 9/19; C25B 9/63; C25B 9/70

(52) U.S. Cl. CPC C25B 9/05; C25B 9/015; C25B 9/19; C25B 9/63; C25B 9/70; C25B 1/04

(57) ABSTRACT

A high-pressure electrolyzer for generating hydrogen and oxygen is provided comprising a plurality of electrolysis units arranged in series, wherein each unit comprises a body of conductive metal made up of an assembly of interconnected horizontal and vertical tubes, said body constituting an electrode which is connectable to a source of DC electricity; wherein said assembly comprises three horizontal tubes and at least two vertical tubes, the vertical tubes each accommodating an elongated central electrode and a tubular membrane, wherein each vertical tube together with the central electrode, the membrane and an electrolyte constitute an electrolytic cell, the electrolytic cells within each unit being connected in parallel, wherein each unit further comprises at least two vertical tubes not accommodating central electrodes, the first vertical tube connecting the lower horizontal tube to the first upper horizontal tube and the second vertical tube connecting the lower horizontal tube with the second upper horizontal tube.

### FIELD OF THE INVENTION

The present invention relates generally to a device for generating hydrogen and oxygen comprising a high-pressure electrolyzer, wherein the electrolyzer comprises a plurality of high-pressure electrolysis units which are arranged in series. The invention also relates to a method to produce high-pressure hydrogen at pressures up to 100.000 KPa or higher and by-product oxygen without the need for a separate compressor to pressurize the hydrogen gas produced.

### BACKGROUND OF THE INVENTION

Electrolytic production of hydrogen is well known. See, for example, WO 2004/076721 and the U.S. patent publications cited therein.

As described in the introduction of WO 2004/076721, known electrolytic equipment, also referred to in the art as “electrolyzers”, using liquid electrolyte to generate hydrogen, operates in the following way. Two electrodes are placed in a bath of liquid electrolyte, such as an aqueous solution of potassium hydroxide (KOH). A broad range of potassium hydroxide concentration may be used, but usually a concentration of about 25 to 30% by weight KOH solution is used. The electrodes are separated from each other by a separation membrane that selectively allows passage of liquid but no gas. When a voltage is impressed across the electrodes, commonly about 2-3 Volts, current flows through the electrolyte between the electrodes. Hydrogen gas is produced at the cathode and oxygen gas is produced at the anode. The separation membrane keeps the hydrogen and oxygen gases separated as the generated gas bubbles rise through the liquid electrolyte. There is a disengagement space above the liquid electrolyte comprised of two separate chambers or two sections isolated from each other by being separated by a gas-tight barrier into two separate sections, one chamber or section to receive the hydrogen gas and the other to receive the oxygen gas. The two gases are separately removed from the respective sections of the disengagement space for storage or venting.

The currently available electrolyzers are mainly low pressure electrolyzers with a stacked design, with sets of prefabricated parts stacked to assemble the electrolyzer. Due to the nature of stacked designs the pressure is limited to about 30 bar.

High-pressure electrolyzers are becoming of major interest since they have the advantage over low-pressure electrolyzers in that they are suitable to be used in high pressure applications, transport and storage without the need for a downstream compressor stage. A variety of designs of high-pressure electrolyzers has been described in the art which are often based on polymer electrolyte membrane (“PEM”) technology. See, for example, WO 2011/012507 A1. However, an important drawback of the PEM technology is that it requires an expensive catalyst of rare metallic material and the catalyst layers in the electrolysis cells degrade faster at varying load requirements than in the alkali electrolysis.

WO 2021/029768 A1 discloses a high-pressure alkaline electrolysis device comprising an assembly of tubes and pipes of electrically conductive metal which constitute either the anode or the cathode, with a channel arrangement of interconnected vertical and horizontal pipes and tubes which are closed at their outer ends except the pipes for water inlet and hydrogen and oxygen outlet connections, wherein the internal face of the channel arrangement is coated with an electrically insulating coating, and wherein the counter electrodes which constitute the cathodes or anodes, respectively, are positioned in the vertical pipes being enveloped by a cylindrical membrane and supported and connected by electrode support bars which are installed in horizontal pipes in the upper part of the housing. The high-pressure electrolysis device further comprises one or more pressure-tight isolated electrical conductors to conduct electrical power supply from the outside to the inside of the electrolysis device.

WO 2004/076721 A2 which corresponds to EP 1597414 B1 discloses an electrolyzer cell for the electrolysis of water which comprises a cathode of generally tubular configuration within which is disposed an anode separated from the cathode by a separation membrane of generally tubular configuration which divides the electrolyte chamber into an anode sub-chamber and a cathode sub-chamber. An electrolyzer apparatus includes an array of individual cells across each of which an electric potential is imposed by a DC generator via electric leads. Hydrogen gas generated within cells from electrolyte is removed via hydrogen gas take-off lines and hydrogen manifold line. By-product oxygen is removed from cells by oxygen gas take-off lines and oxygen manifold line.

NL 2023212 discloses a high-pressure electrolysis device comprising a massive block of electrically conductive metal, which constitutes either the anode or the cathode, with an arrangement of interconnected vertical and horizontal cylindrical channels, which are closed at the outer ends except the channels for water inlet and hydrogen and oxygen outlet connections, wherein the internal face of the channel arrangement is partially coated with an electrically insulating coating, and wherein the counter electrodes which constitute the cathodes or anodes, respectively, are positioned in the vertical channels enveloped by a cylindrical membrane and supported and connected by electrode support bars which are installed in horizontal channels in the upper part of the housing.

EP 3 498 886 A1 discloses an electrolysis system to conduct oxidation and reduction reactions comprising two or more groups of electrolytic cells which are connected in parallel, the electrolytic cells being formed by at least a pair of electrodes and an electrolyte between the electrodes, wherein the assembly of said electrolytic cells defines an electrolyzer; an energy source that supplies an electrical signal to the electrolyzer; wherein the electrical signal received by the electrolytic cells that form the electrolyzer correspond to a direct current pulse which is configured for each electrolyzer's cells to operate in a charge transient regime of each cell during the direct current pulse and in a discharge transient regime of each cell during the time between the direct current pulses, wherein said charge and discharge transient regimes are defined by the construction of each electrolytic cell in the form of a cylindrical plates capacitor.

U.S. Pat. No. 3,984,303 discloses an electrolytic cell for the production of halogen gas and alkali metal hydroxide, having a hollow tubular cathode member with a hollow tubular anode member disposed concentrically within the cathode, each electrode member having liquid permeable walls to allow the circulation of electrolyte. The anode is covered on its outer surface with an electrically conductive, tubular membrane of a material selectively permeable to the passage of ions and impervious to hydrodynamic flow of the electrolyte, which is fitted over the outer surface of the anode, thereby separating the anode and cathode surfaces. Such cells may also be connected in series to form a larger multi-cell electrolyzer.

There is still a need for simple, efficient and cost-effective high-pressure electrolyzers for the production of hydrogen and other industrial processes, which are compact, flexible, modular, scalable, and require low maintenance. It is an object of the present invention to provide such a high-pressure electrolysis device.

### SUMMARY OF THE INVENTION

In one aspect of the present invention a high-pressure electrolysis unit for generating hydrogen and oxygen is provided comprising:
a body of electrically conductive metal, made up of an assembly of inter-connected horizontal and vertical tubes, said body constituting an electrode, anode or cathode, which is connectable to a source of DC electricity;
wherein said assembly comprises three horizontal tubes, the first tube, defined as the lower horizontal tube constituting the bottom of the body and the two other tubes, defined as the first upper horizontal tube and the second upper horizontal tube, respectively, which are situated at neighbouring distance from each other in the upper part of the body;
wherein said assembly comprises at least two vertical tubes, the vertical tubes being arranged in a row and having lower and upper outer ends, the lower outer ends being connected to said lower horizontal tube and the upper outer ends being sealed;
wherein the vertical tubes extend from the lower horizontal tube, are then interconnected with the second upper horizontal tube and the first upper horizontal tube, and extend further to beyond the first upper horizontal tube, the upper outer parts constituting the top of the body;
wherein each of said vertical tubes accommodate an elongated central electrode, which is electrically isolated from the vertical tube and defines a counter electrode, cathode or anode, respectively, each central electrode extending from the lower part of the respective vertical tube and protruding through the seal to beyond the upper outer end of said vertical tube, said central electrodes being connectable to a source of DC electricity;
wherein a separation membrane of tubular configuration, extending from the area between the connection of the vertical tube with the lower horizontal tube and the lower outer end of the central electrode up to the area between the second upper and first upper horizontal tube, is placed within each vertical tube, concentric between the cathode and the anode to divide said cell into an anode sub-chamber and a cathode sub-chamber, the separation membrane sealing against the passage therethrough of gases but permitting passage of liquid and liquid borne ions;
wherein gas-tight seals are placed between said separation membrane and the inner wall of the vertical tube between the two upper horizontal tubes of the body, which are also supporting the membrane;
wherein each central electrode together with the inner wall of the vertical tube surrounding said central electrode, the tubular membrane and an electrolyte provided between said electrodes defines an electrolytic cell; and
wherein the body further comprises at least two additional vertical tubes not accommodating central electrodes, the first vertical tube connecting the lower horizontal tube to the first upper horizontal tube and the second vertical tube connecting the lower horizontal tube to the second upper horizontal tube.

In another aspect of the invention a high-pressure electrolyzer is provided comprising a plurality of high-pressure electrolysis units as defined above, which are electrically connected in series.

In still another aspect of the invention a high-pressure electrolyzer is provided comprising a plurality of high-pressure electrolysis units as defined above, further comprising a cooling and drying unit.

In a further aspect of the invention a device is provided comprising a high-pressure electrolyzer comprising a plurality of high-pressure electrolysis units as defined above, and one or more pressure containers

These and other aspects of the present invention will be more fully outlined in the detailed description which follows with reference to a particular embodiment thereof, i.e. the production of hydrogen and oxygen by high-pressure electrolysis of water. However, those skilled in the art will recognize that the invention may be utilized in other embodiments.

Conventional known devices such as pressure-sensing and flow-rate sensing devices, and controls to operate valves and pumps, have been largely omitted from the description, as such devices and their use are well known in the art.

### BRIEF DESCRIPTION OF THE DRAWINGS

FIG. 1 is a schematic front side view of an embodiment of a high-pressure electrolysis unit according to the invention;

FIG. 2 is a schematic side view of the electrolysis unit of FIG. 1;

FIG. 3 is a schematic perspective view of another embodiment of a high-pressure electrolysis unit according to the invention;

FIG. 4 is a detailed view of the upper part of a vertical tube with an elongated electrode mounted therein;

FIG. 5 is a partial longitudinal view of an electrolysis cell according to the state of the art, and a cross-sectional and a perspective view of an embodiment of an electrolysis cell which forms part of a high-pressure electrolysis unit according to the invention;

FIG. 6 is a perspective view of an embodiment of a high-pressure electrolysis unit according to the invention;

FIG. 7 is a schematic side view of an embodiment of four high-pressure electrolysis units according to the invention in a serial arrangement;

FIG. 8 is a perspective view of an embodiment of an electrolyzer with multiple (16) high-pressure electrolysis units according to the invention in a serial arrangement, and cooling and drying devices for the generated gases connected thereto;

FIG. 9 is a schematic view of the electrolyzer of FIG. 8;

FIG. 10 is a more detailed schematic view of the cooling device of FIG. 9;

FIG. 11 is a flow chart of an embodiment of the cooling device for the generated gases in an electrolyzer according to the invention.

The following detailed description should be read with reference to the drawings in which like elements in different drawings are numbered identically. The drawings, which are not necessarily to scale, depict selected embodiments and are not intended to limit the scope of the invention.

### DETAILED DESCRIPTION OF THE INVENTION

A high-pressure electrolysis unit according to the invention comprises a body made up of an assembly of interconnected horizontal and vertical tubes of high-pressure and temperature-resistant conductive material, and no stacked design. The assembly is used as the containment for the high-pressure electrolysis process. High operating pressures are possible and no compression is needed to store and distribute product gas, resulting in an increased total efficiency, as no compression of the product gas is needed downstream.

The words “tubes” and “pipes” are frequently used interchangeably in the art, although there are differences between lubes and pipes. Reference may be made to, e.g., http://www.wermac.org/pipes/pipe_vs_tube.html. As used herein, “tubes” and “pipes” are collectively referred to as “tubes”, unless stated otherwise. A skilled person in the art will have no problem in understanding which materials are needed when applying a design according to the invention.

The body of the electrolysis unit constitutes an electrode, anode or cathode, which is connectable to a source of DC electricity. In a preferred embodiment, the assembly of interconnected horizontal and vertical tubes comprises three horizontal tubes. One tube, hereinafter referred to as the lower horizontal tube, constitutes the bottom of the body. The two other tubes, hereinafter referred to as the first upper horizontal tube and the second upper horizontal tube, respectively, are situated at neighbouring distance from each other and form part of the upper part of the body.

The assembly of interconnected horizontal and vertical tubes comprises at least two, and preferably a plurality of vertical tubes, e.g. from three to twenty up to fifty or more vertical tubes. A preferred number of vertical tubes is in the range of 15-50 tubes per electrolysis unit. The vertical tubes having lower and upper outer ends are arranged in a row, the lower outer ends being connected to the lower horizontal tube. The vertical tubes extend from the lower horizontal tube, are interconnected with the second upper horizontal tube and the first upper horizontal tube, and extend further to beyond the first upper horizontal tube. The upper outer ends of the vertical tubes constitute the top of the body and are sealed. In a preferred embodiment, the upper outer ends of the vertical tubes are threaded to facilitate maintenance of the unit and assembly of other parts into the vertical tubes. The vertical tubes may be closed with readily available pressure fittings which are known in the art, such as threaded pressure fittings.

The vertical tubes are adapted to accommodate elongated electrodes which are isolated from the wall of the tubes. In a preferred embodiment, each of the vertical tubes accommodate an elongated central electrode, which extends from the lower part of said vertical tube upwards and protrude through the seal of the upper outer end of the vertical tube to beyond said upper outer end. The elongated central electrodes constitute counter electrodes, cathode or anode, respectively, relative to the electrode of the body, which are connectable to a source of DC electricity. In a preferred embodiment, the elongated central electrodes are solid, cylindrical bar or rod type electrodes.

The body is filled with a liquid electrolyte, for example a solution of potassium hydroxide (KOH) in demineralized water. A broad range of potassium hydroxide concentrations may be used, but generally a concentration of about 25 to 30 wt. % KOH solution is used. The electrodes, i.e. the vertical tubes which are part of the conductive body and the central electrodes are exposed to, and in contact with, the liquid electrolyte to generate gases when in operation.

A separation membrane of tubular configuration is placed within each vertical tube surrounding the central electrode and thus dividing the concentric space within the vertical tube into an anode sub-chamber and a cathode sub-chamber, the separation membrane sealing against the passage therethrough of gases but permitting passage of liquid and liquid borne ions. The separation membrane is top supported and extends from the area between the connection of the vertical tube with the lower horizontal tube and the lower outer end of the central electrode up to the area of the vertical tube between the second upper horizontal tube and the first upper horizontal tube. In a preferred embodiment, the separation membranes are open at the lower side. In another preferred embodiment, the membrane is a ZIRFON® separation membrane¹. 1 ZIRFON® is a registered trade mark

Gas-tight seals are placed between the separation membranes and the inner wall of the vertical tubes between the two upper horizontal tubes. These seals also support the membrane. The upper part of the central electrodes is preferably electrically isolated around their circumference, crossing the area of the upper two horizontal tubes, upwards from the seals to prevent generation of gases in the two upper horizontal tubes, enabling high quality of the gas produced.

Each central electrode together with the inner wall of the vertical tube in which the central electrode is placed, the separation membrane and the electrolyte between said electrodes, define an electrolytic cell. In a preferred embodiment, the inner wall of the vertical tube constitutes the anode (+) and the central electrode constitutes the cathode (−) of the electrolysis cell.

In a particular preferred embodiment, the body further comprises at least two vertical tubes which do not accommodate central electrodes. The first vertical tube connects the lower horizontal tube to the first upper horizontal tube and the second vertical tube connects the lower horizontal tube to the second upper horizontal tube. These additional tubes are advantageous for the recirculation of the electrolyte and improve the removal of the generated gases from the electrolytic cells.

In a preferred embodiment, the high-pressure electrolysis unit according to the invention comprises two or more electrolytic cells, e.g. 3, 4, 5, 6, 7, 8, or a plurality of cells up to 50, which cells are connected in parallel. In a further preferred embodiment, the upper parts of the central electrodes are electrically interconnected outside the vertical tubes, e.g. by a conductive profile which in turn is connected to a source of DC electricity.

When in operation, hydrogen gas is produced at the cathode and oxygen gas is produced at the anode of each electrolytic cell. The separation membrane keeps the hydrogen and oxygen gases separated as the generated gas bubbles rise through the liquid electrolyte. There is a disengagement space above the liquid electrolyte comprised of two sections which are separated from each other by the gas-tight seal, one section, i.e. the first upper horizontal tube, to receive the hydrogen gas and the other section, i.e. the second upper horizontal tube, to receive the oxygen gas. The two gases are separately removed from the respective tubes for cleaning and drying, storage, transport or venting.

Each electrolysis unit comprises at least one and preferably two gas take-off connections in liquid-and gas-flow communication with the respective two upper horizontal tubes for removing from the tubes gases generated in the electrolytic cells and collected in said tubes. In addition, each unit comprises a connection for a feeding conduit to supply liquid electrolyte or demin-water, preferably to the lower horizontal tube of the unit.

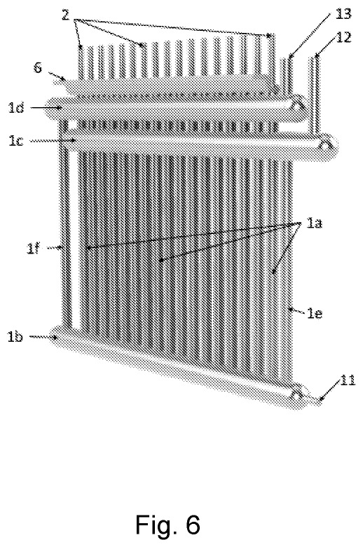

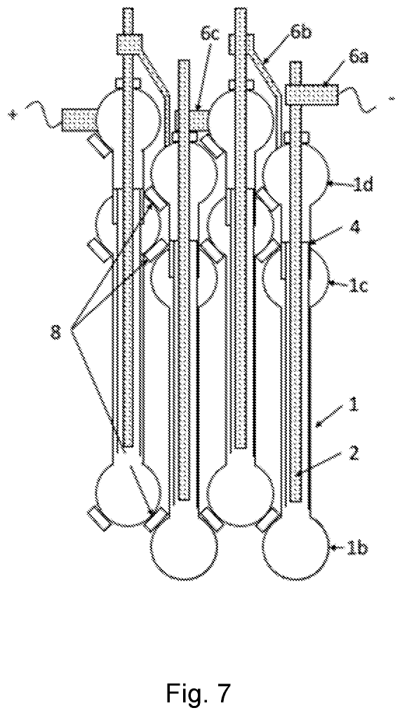

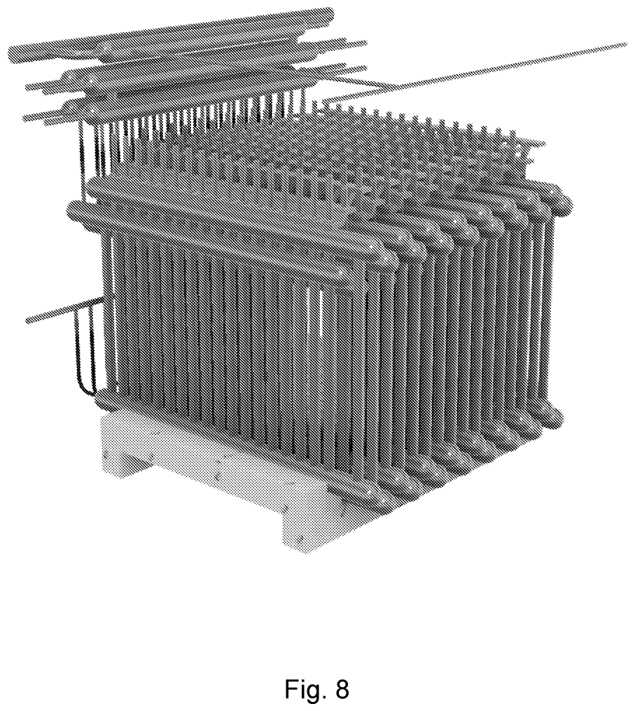

In a further aspect of the invention a high-pressure electrolyzer is provided comprising a plurality of high-pressure electrolysis units as defined and described above, which are connected in series. The combined electrolysis units are preferably arranged in electrically isolated adjacent arrays, for example in a way as illustrated in FIG. 7 and FIG. 8. As exemplified in FIG. 6, the units are electrically connected such that the anode (+) of the body of the first unit is connected a source of DC electricity, the cathode (−) of the central electrode of the first unit is connected to the body of the second adjacent electrolysis unit, the central electrode of the second electrolysis to the body of the next adjacent electrolysis unit, and so on, and the last central electrode (−) is connected to the source of DC electricity. The differential voltage over the serially connected units is equal to the number of units multiplied by the voltage drop over a single unit, which is in the range of 2-3 Vdc. The current is equal to the number of parallel cells multiplied by the current through a single cell, which is dependent on the detailed design of the cell and the voltage applied over the cell.

The high-pressure electrolyzer according to the invention comprises at least two electrolysis units, but preferably a plurality thereof, e.g. at least 10 units, more preferably at least 50-150 units. In a preferred embodiment, the electrolysis units are further bound by common feeding conduits of liquid electrolyte and demin-water, as well as gas take-off conduits of the hydrogen and oxygen gases.

The wall thickness of the body of the high-pressure units according to the invention is dictated by the desired generation pressure, by material properties such as yield strength and electrical conductivity of the metal from which the body is made. Generally, the wall thickness may vary from about 0.65 to 1.60 cm. Typically, the length of the vertical pipes of the high-pressure units is in the range of 500 to 2000 mm and may be further developed up to 4000 mm. Typically, the diameter of the central electrode is about 30 mm and may be further developed up to 100 mm. These values are merely indicative and not to be construed as limiting the invention in any respect.

In a further aspect of the invention one or more cooling and drying units are provided which form part of the high-pressure electrolysis device according to the present invention. The cooling and drying units are connected with the take-off conduits of the produced hydrogen and oxygen gases.

In a preferred embodiment, the produced hydrogen and oxygen gases are conveyed to a cooling and drying device to be cooled down by a cooling medium, e.g. cooling water. After cooling, the oxygen gas is reduced to atmospheric pressure which results in another temperature reduction due to the thermodynamic behavior of oxygen. The oxygen at ambient conditions is then used to further cool down the hydrogen gas which still is under high pressure. The gas cooling unit is designed such that condensed water runs back into the electrolysis units. Condensation of water vapor in the downstream systems is avoided. Thus, by cooling the hydrogen gas below ambient temperature it will be dried to a saturation temperature below atmospheric conditions, thereby preventing water condensation in downstream systems.

In another aspect of the invention, one or more pressure containers are provided which form part of the electrolysis device according to the present invention. The pressure containers are preferably releasably connected to the cooling and drying units for storage of the dried and purified gases.

The electrolyzer according to the present invention has several advantages as compared to prior art electrolyzers of similar type. These advantages inter alia relate to: a) the high-pressure environment, b) gas-liquid separation, c) natural circulation and removal of produced gases from the electrolytic cells by gravity effects, d) isolation of the central electrode, e) simplified maintenance of the apparatus, f) cooling of the produced gases.

Regarding the high-pressure environment, the pressure containment is also one of the electrodes. The coaxial anode/cathode configuration allows very high-pressure hydrogen generation with practical wall thicknesses of conventional materials in the containment body provided by the anode. Conventional stacked concepts have large plates, which enable that high currents flow through the system. The perimeter of the plates is also the perimeter which must be kept pressure-tight. The present electrolyzer is designed such that the anode/cathode configuration and the circumference of the openings of the first and second upper horizontal tubes are significantly smaller than the perimeter of the plates in the stacked concepts, which results in a reduced area for potential leakages of combustible gases.

The high pressure in the electrolysis units results in smaller gas volumes in the electrode area and subsequently large electrolyte volume, which in turn results in lower electrical resistance and thus a better efficiency.

The ability of the apparatus and method of the present invention to enable hydrogen (and oxygen) production at pressures of up to or even exceeding 1000 bar exceeds the highest pressure of the prior known electrolyzers. The apparatus and method of the present invention can produce such high-pressure hydrogen without need for a separate compressor to pressurize the product hydrogen gas. The device according to the present invention allows high-pressure hydrogen production to be performed in a unique way that reduces the component cost and system complexity so that the equipment is easily affordable. The device is scalable to any given production capacity.

Regarding the gas-liquid separation, the circulation of the liquid electrolyte and the generated gases is improved by the assembly of horizontal and vertical tubes according to the invention, in particular by the two additional vertical tubes which connect the lower horizontal tube with the first and second upper horizontal tubes, respectively. These additional vertical tubes enable the downstream of the electrolyte due to the hydraulic phenomenon in the other vertical tubes resulting from producing gas in the electrolytic cells. The produced gases are removed from the electrode surfaces by natural draft which improves the capacity of the system. No active circulation system is needed. Collecting headers are included in the electrolyzer according to the invention to enable or improve the natural circulation and gas separation in the high-pressure electrolysis units.

Regarding the circulation of the electrolyte and the removal of the produced gases from the electrolytic cells, the assembly of horizontal and vertical tubes of the electrolysis unit of the invention is designed such that no active circulation system is needed to remove the produced gases from the electrodes, improving the capacity of the system. Natural draft is established by the vertical pipes not housing a central electrode, thus kept open to enable a downstream of the electrolyte due to the hydraulic phenomenon in the vertical cells resulting from producing gas in the electrolytic cells. The prior art is silent about these features.

Regarding the isolation of the central electrode, the central electrode preferably is a solid, bar type electrode. The upper part of the electrode is electrically isolated to prevent generation of gases in the collecting headers, i.e. the two upper horizontal tubes, enabling high quality of the gas produced. This is an improvement compared to, e.g., EP 3 498 886 A1 where no measures are disclosed to prevent the production of gases in the collecting headers.

Regarding maintenance of the apparatus, the outer upper parts of the vertical tubes which accommodate the central electrodes are preferably threaded and provided with releasably threaded pressure fittings. Furthermore, the central electrodes and surrounding separation membranes are preferably top supported only, enabling easy removal of the central electrodes and membranes for maintenance or replacement. Therefore, the maintenance of the apparatus is simplified, more efficient and cheaper.

Regarding the cooling of the produced gases, the gas cooling unit of the invention provides that by cooling the hydrogen gas it will be dried to a saturation temperature below atmospheric conditions, thereby preventing water condensation in the downstream systems. The prior art is silent about this feature.

The apparatus and method of the present invention may be utilized to generate high-pressure hydrogen on site at locations such as service stations for hydrogen fuel cell-powered automobiles; local energy producers or distributors for retail sale of hydrogen fuel via high-pressure canisters; factories such as (petro) chemical plants, power plants and office buildings for on-site energy storage and/or use as chemical feedstock, use in fuel cell or internal combustion engine-based heart and/or power production.

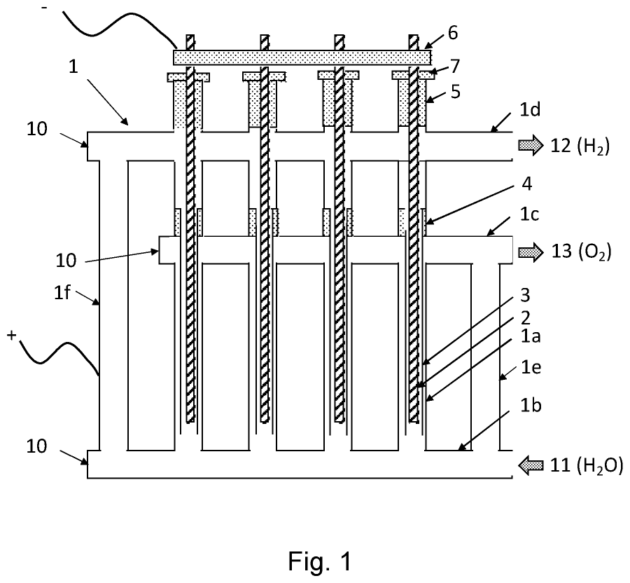

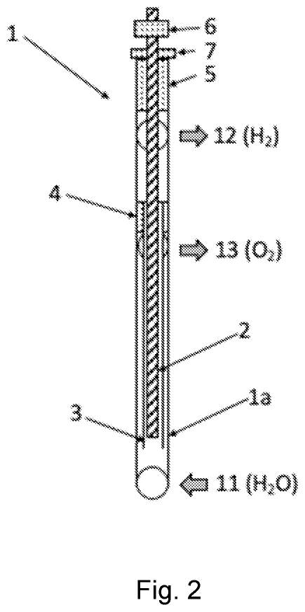

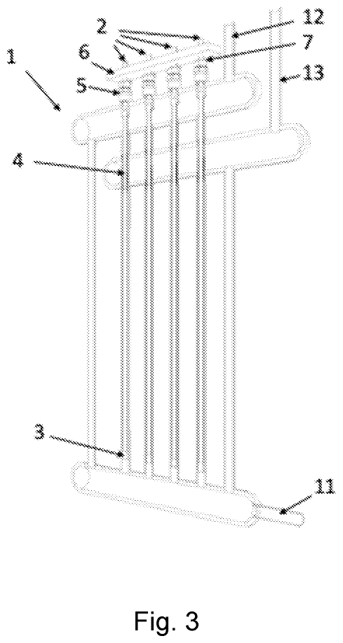

Turning to the drawings, with particular reference to FIGS. 1-3, there is shown an embodiment of a high-pressure electrolytic cell unit, comprising four parallel electrolytic cells, wherein the unit is made up from an assembly of three horizontal and four vertical interconnected tubes 1a, 1b, 1c, 1d, the latter arranged in a row, as well as two additional vertical tubes 1e and 1f, all made from an electrically conductive metal, constituting an electrically conductive body 1 which encloses the pressurized containment for the electrolyte and gases. An inlet 11 for liquid electrolyte or water is provided at the lower horizontal tube of the body and two gas outlets 12, 13 are provided at two upper horizontal tubes 1d and 1c, for exiting the produced gases hydrogen and oxygen, respectively. The body of 1 is connectable to a source of DC electricity, in this embodiment an anode (+). The multiple vertical tubes are represented by reference sign 1a. These tubes each contain an electrolysis cell, enclosing a counter electrode 2, in this embodiment defined as cathode (−), which is situated centrally in the vertical tubes 1a. The lower horizontal tube 1b connects the vertical tubes 1a at their lower outer ends and provides a uniform distribution of the electrolyte over the multiple cells which form part of the electrolytic cell unit. The second upper horizontal tube 1c and the first horizontal tube 1d are located at neighbouring distance at the upper part of the vertical tubes 1a and are interconnected with the vertical tubes, comprising the oxygen and hydrogen separation (separating the electrolyte and the gas) and collecting headers. The tubes 1e and 1f are the downcomers, returning the excess electrolyte from the horizontal headers 1c and 1d, respectively. Cylindrical membranes 3 are positioned concentrically around the central electrodes 2 and are supported by membrane support and sealing fittings 4, which are rigidly fitted in the vertical tubes 1a between the horizontal headers 1c and 1d. The central electrodes 2 are arranged in the vertical tubes 1a and supported by pressure tight and electrically isolated fittings 5. The conductive connecting profile 6 electrically interconnects the parallel arranged counter electrodes 2 at the top of the assembly, outside the electrolytic cell unit 1. The electrically isolating rings 7 isolate the body of the electrolytic cell unit 1 from the electrodes 2 and the conductive connecting profile 6.

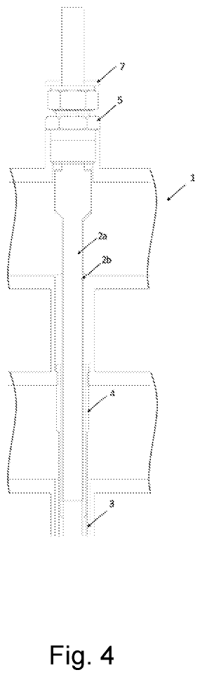

FIG. 4 shows the upper part of an electrolytic cell in more detail, in particular the relative arrangement between the body 1, the separation membrane 3 and the support and sealing fitting 4, and the electrode 2a, the electrode isolation 2b, the electrode sealing fitting 5 and the isolating ring 7.

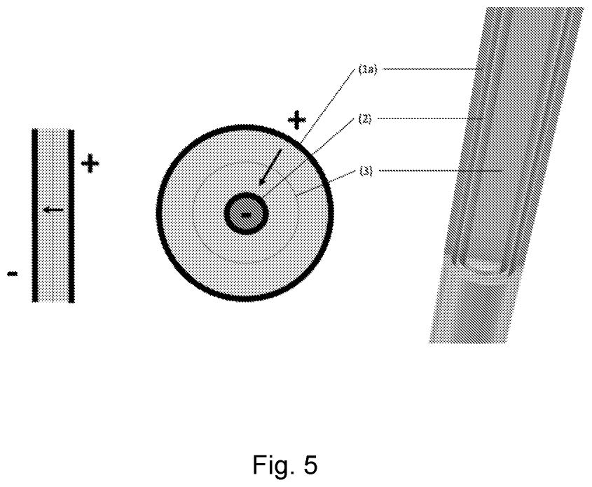

FIG. 5 shows at the left-hand side a schematic of a cell of a prior art stacked type electrolyzer, whereas at the right-hand a cell of the current invention is shown, i.e. a cross section of a vertical tube 1a with central electrode 2 and membrane 3.

FIG. 6 shows a 3-dimensional view of an embodiment of a of high-pressure electrolysis unit, as described in FIGS. 1-3, with 17 electrolytic cells in parallel.

FIG. 7 shows a schematic view of four high-pressure electrolytic cell units, described in the previous figures, which are connected in series. The body 1 of one unit is connected to the central electrodes 2 of the neighbouring unit by various types of electrical connecting profiles 6a, 6b and 6c. The bodies of the individual units are each electrically isolated by electrically isolating pads 8.

FIG. 8 is a perspective view of an embodiment of an electrolyzer with multiple (16) high-pressure electrolysis units in a serial arrangement, together with a cooling and drying unit for the generated gases connected thereto;

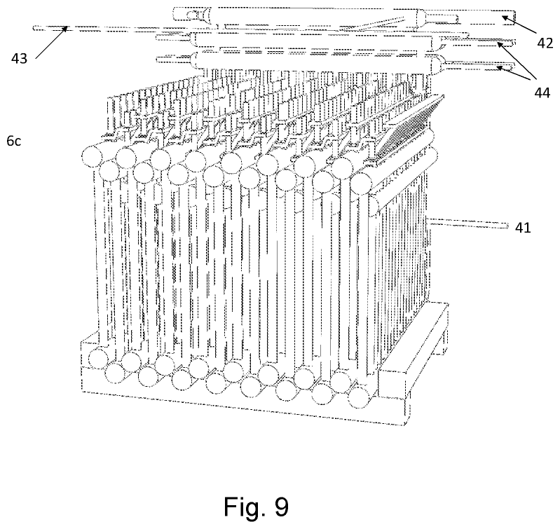

FIG. 9 is a scheme of a part of an electrolytic plant module showing the electrolyzer of FIG. 8 and a cooling and drying unit, the device comprising a feeding conduit 41 for (demin) water, main extraction conduit 43 of the reaction product hydrogen, and main extraction conduit 42 of the oxidation reaction product (oxygen). Also shown are the feeding conduits 44 for cooling medium. This scheme allows designing one or more modules for the feeding of each unit of cells in order to cover the needs of current and voltage according to the statements of the invention.

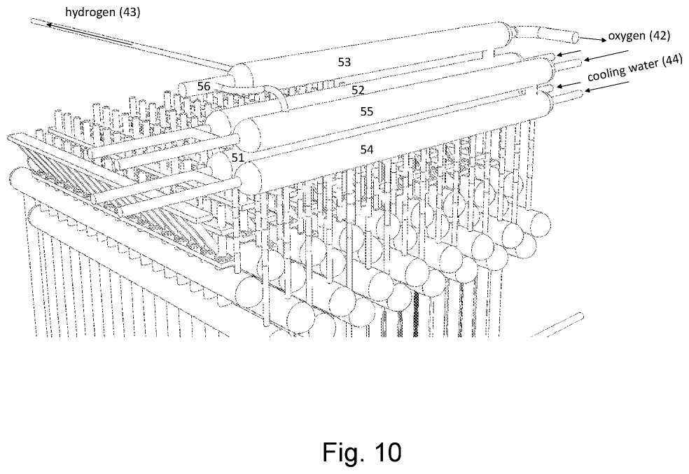

FIG. 10 shows an isometric picture of the embodiment of the invention including the cooling and drying system.

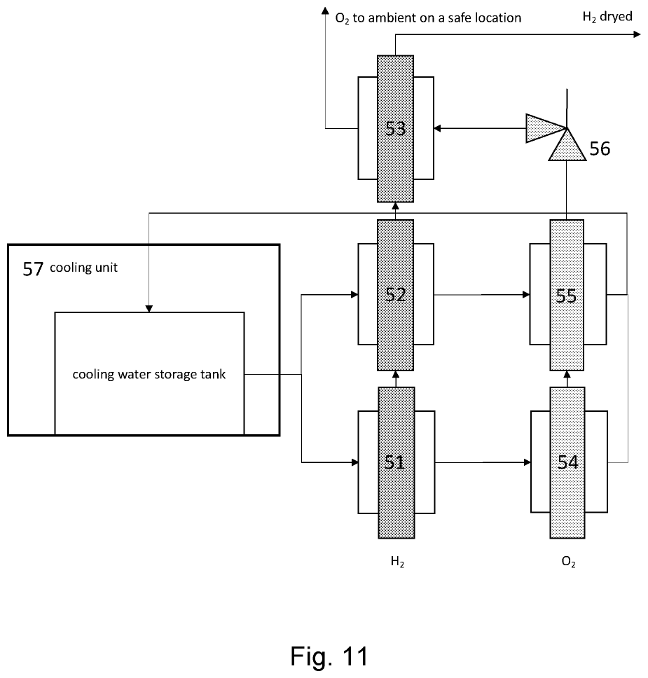

FIG. 11 shows a schematic view of the embodiment of the invention including the cooling and drying system, comprising the heat exchangers 51, 52, and 53 for hydrogen 54 and 55 for oxygen, external cooling system 57 and pressure reduction station 56.

### Operation

The empty racks, unit(s) will be filled with electrolyte (first filling, the electrolyte being a solution of 25-30% potassium hydroxide in demineralized water) with all venting devices in open position, until a maximum level in the racks has been secured.

Then the electrolysis process is started by connecting the unit to an electrical DC source and creating a voltage drop over every single electrolysis cell of 2-3 V. Hydrogen gas will be produced at the surface of the center electrode (cathode) and oxygen will be produced at the inner surface of the surrounding vertical tube (anode). The gases produced will rise to and collected into the first upper and the second upper horizontal tube, respectively, and subsequently be blown off to the environment. After some time the venting devices will be closed when all downstream volume has been purged by the produced gases and no air is remaining in the downstream system. Pressure will build up in the system as the volumes of the produced gases are far more larger than the converted water volume.

Natural circulation via the downcomers will support the removal of the produced gases from the electrolytic cell area and the collection of the gases in the headers.

When the operational pressure has been reached the gas pressure control system will blow off the excess gases to the downstream systems, e.g. storage and/or pipe line system. The converted amount of water will be made up by demineralized water when the water level reaches low or controllable level.

The produced hydrogen and oxygen gases will be cooled down by a cooling medium, e.g. cooling water. After cooling, the oxygen gas pressure will be reduced to atmospheric pressure, resulting in another temperature reduction due to the thermodynamic behavior of oxygen. The cold oxygen at ambient pressure is then used to cool down the still pressurized hydrogen even further.

The cooling devices are designed such that condensed water vapor will run back into the electrolyzer cells.

Upon cooling the hydrogen gas as described it will be dried to a saturation temperature below atmospheric conditions, thereby preventing condensation of water vapor in the downstream systems.

From the foregoing description, a person skilled in the art can easily ascertain the essential characteristics of the present invention, and without departing from the spirit and scope thereof, can make various changes and modifications to adapt it to various usages and conditions. These modifications and adaptations are therefore deemed to fall within the scope of protection of this invention as claimed in the appended claims.

1. A high-pressure electrolysis unit for generating hydrogen and oxygen, comprising:
a body of electrically conductive metal, made up of an assembly of inter-connected horizontal and vertical tubes, said body constituting an electrode, anode or cathode, which is connectable to a source of DC electricity;
wherein said assembly comprises three horizontal tubes, the first tube, defined as the lower horizontal tube, constituting the bottom of the body and the two other tubes, defined as the first upper horizontal tube and the second upper horizontal tube, respectively, which are situated at neighboring distance from each other in the upper part of the body;
wherein said assembly comprises at least two vertical tubes, the vertical tubes being arranged in a row and having lower and upper outer ends, the lower outer ends being connected to said lower horizontal tube and the upper outer ends being sealed with a seal;
wherein the vertical tubes extend upwards from the lower horizontal tube, are then interconnected to the second upper horizontal tube and the first horizontal tube, and extend further beyond the first upper horizontal tube, the upper outer parts constituting the top of the body;
wherein each of said vertical tubes accommodate an elongated central electrode, which is electrically insulated from the vertical tube and defines a counter electrode, a cathode or an anode, respectively, each center electrode extending from the lower part of the respective vertical tube and protruding through the seal to above the upper outer end of said vertical tube, said center electrodes being connectable to a source of DC electricity;
wherein a separating membrane of tubular configuration is placed within each vertical tube, concentric between the cathode and the anode to divide the cell into an anode sub-chamber and a cathode sub-chamber, the separating membrane extending from the area between the junction of the vertical tube with the lower horizontal tube and the lower outer end of the central electrode up to the area between the second and first horizontal tube, and where the separating membrane seals against the passage of gases, but allows passage of liquid and the ions contained therein;
wherein gas-tight seals are placed between the separating membrane and the inner wall of the vertical tube between the first upper horizontal tube and the second horizontal tube of the body, said seals also supporting the membrane;
wherein each central electrode, together with the separating membrane and the inner wall of the vertical tube surrounding said central electrode and an electrolyte provided between said electrodes, defines an electrolytic cell; and
wherein the body further comprises two vertical tubes in which no central electrodes are accommodated, the first vertical tube connecting the lower horizontal tube to the first upper horizontal tube and the second vertical tube connecting the lower horizontal tube to the second upper horizontal tube.

2. The high-pressure electrolysis unit of claim 1, wherein the upper outer ends of the central electrodes are conductively interconnected outside the vertical tubes, preferably by means of a profile of conductive material.

3. The high-pressure electrolysis unit of claim 1, wherein the upper part of the central electrodes is electrically insulated about their periphery above seal over the part where the central electrode passes through the upper two horizontal tubes.

4. The high-pressure electrolysis unit of claim 1, wherein the seals of the upper outer ends of the vertical tubes and the center electrodes are releasably arranged, allowing maintenance or replacement of the center electrodes and/or separating membranes.

5. The high-pressure electrolysis unit of claim 1, wherein the upper outer ends of the vertical tubes, which accommodate the central electrodes, are threaded.

6. The high-pressure electrolysis unit of claim 1, wherein the electrolysis unit comprises two or more electrolytic cells which are interconnected in parallel.

7. The high-pressure electrolysis unit of claim 1, further comprising a fluid supply connection which is in fluid communication with the electrolytic cells for supplying electrolyte and/or demineralized water to the electrolytic cells or to fill in.

8. The high-pressure electrolysis unit of claim 1, further comprising at least one connection for the discharge of gases, said at least one connection being in gas communication with the electrolytic cells to remove the gases which are generated in the electrolytic cells.

9. The high-pressure electrolysis unit of claim 1, wherein the elongated central electrodes are rod-shaped.

10. The high-pressure electrolysis unit of claim 1, wherein the separating membrane is open at the bottom of the membrane.

11. The high-pressure electrolysis unit of claim 1, wherein the separating membrane is a ZIRFON® separating membrane.

12. The high-pressure electrolysis unit of claim 1, wherein the body constitutes the anode (+) and the central electrode constitutes the cathode (−), the vertical tube (+), the separating membrane and the central electrode (−) being arranged coaxially.

13. A system for generating hydrogen and oxygen, the system comprising a plurality of high-pressure electrolysis units, each of the plurality of the high-pressure electrolysis units for generating hydrogen and oxygen, the plurality of the high-pressure electrolysis units comprising:
a body of electrically conductive metal, made up of an assembly of inter-connected horizontal and vertical tubes, said body constituting an electrode, anode or cathode, which is connectable to a source of DC electricity;
wherein said assembly comprises three horizontal tubes, the first tube, defined as the lower horizontal tube, constituting the bottom of the body and the two other tubes, defined as the first upper horizontal tube and the second upper horizontal tube, respectively, which are situated at a neighboring distance from each other in the upper part of the body;
wherein said assembly comprises at least two vertical tubes, the vertical tubes being arranged in a row and having lower and upper outer ends, the lower outer ends being connected to said lower horizontal tube and the upper outer ends being sealed with a seal;
wherein the vertical tubes extend upwards from the lower horizontal tube and are then interconnected to the second upper horizontal tube and the first horizontal tube, and extend further beyond the first upper horizontal tube, the upper outer parts constituting the top of the body;
wherein each of said vertical tubes accommodate an elongated central electrode, which is electrically insulated from the vertical tube and defines a counter electrode, a cathode or an anode, respectively, each center electrode extending from the lower part of the respective vertical tube and protruding through the seal to above the upper outer end of said vertical tube, said center electrodes being connectable to a source of DC electricity;
wherein a separating membrane of tubular configuration is placed within each vertical tube, concentric between the cathode and the anode to divide the cell into an anode sub-chamber and a cathode sub-chamber, the separating membrane extending from the area between the junction of the vertical tube with the lower horizontal tube and the lower outer end of the central electrode up to the area between the second and first horizontal tube, and where the separating membrane seals against the passage of gases, but allows passage of liquid and the ions contained therein;
wherein gas-tight seals are placed between the separating membrane and the inner wall of the vertical tube between the first upper horizontal tube and the second horizontal tube of the body, said seals also supporting the membrane;
wherein each central electrode, together with the separating membrane and the inner wall of the vertical tube surrounding said central electrode and an electrolyte provided between said electrodes, defines an electrolytic cell; and
wherein the body further comprises two vertical tubes in which no central electrodes are accommodated, the first vertical tube connecting the lower horizontal tube to the first upper horizontal tube and the second vertical tube connecting the lower horizontal tube to the second upper horizontal tube wherein the plurality of high-pressure electrolysis unit are connected in series.

14. The system according to claim 13, wherein the plurality of high-pressure electrolysis units are connected with one or more cooling and drying units.

15. The system according to claim 13, wherein the system further comprises one or more containers for the storage of the hydrogen gas produced.
